(19) United States
(12) Patent Application Publication
(10) Pub. No.: US 2025/0045549 A1
(43) Pub. Date: Feb. 6, 2025

(54) IMAGE FORMING APPARATUS

(71) Applicant: CANON KABUSHIKI KAISHA, Tokyo (JP)

(72) Inventor: SHINYA IKEDA, Ibaraki (JP)

(21) Appl. No.: 18/788,673

(22) Filed: Jul. 30, 2024

(30) Foreign Application Priority Data
Aug. 3, 2023 (JP) 2023-127037

(51) Int. Cl. G06K 15/02; H04N 1/00

(52) U.S. Cl. CPC G06K 15/027; H04N 1/00795; H04N 2201/0081

(57) ABSTRACT

An image forming apparatus includes an image forming unit configured to form an image on a sheet based on image data, a reader configured to read the sheet on which the image has been formed, an inspector configured to execute an inspection of a reading result of the image read by the reader, a display configured to display an inspection result of the inspection executed by the inspector, and a controller configured to execute main printing for controlling the image forming unit to form an image based on the image data, or test printing for controlling the image forming unit to form an image based on only a part of the image data, wherein the display is configured to display first information and second information.

### BACKGROUND OF THE INVENTION

### Field of the Invention

The present disclosure relates to an image forming apparatus having a printing inspection function of performing a quality inspection of an image printed on a sheet.

### Description of the Related Art

An image forming apparatus executes a print job for generating a printed matter by printing an image on a sheet based on image data representing an image to be printed. In particular, an image forming apparatus for use in a commercial printing site (hereinafter referred to sometimes as “production printing machine”) may print a large number of copies or a large number of pages in one print job. In US 2021/0365219, there is disclosed a method of executing test printing for printing only a specific page before main printing.

A printing inspection apparatus inspects whether or not an image printed on a sheet by an image forming apparatus has been formed as instructed by image data. In US 2023/0112594, there is disclosed a printing inspection apparatus in which image data is set as reference data, scan data obtained by reading an image printed on a sheet through use of a sensor such as a scanner is set as inspection image data, and the image data and the scan data are compared to each other. The printing inspection apparatus determines print quality of a printed matter based on the degree of agreement between the reference data and the inspection image data.

### SUMMARY OF THE INVENTION

An image forming apparatus according to the present disclosure includes an image forming unit configured to form an image on a sheet based on image data, a reader configured to read the sheet on which the image has been formed, an inspector configured to execute an inspection of a reading result of the image read by the reader, a display configured to display an inspection result of the inspection executed by the inspector, and a controller configured to execute main printing for controlling the image forming unit to form an image based on the image data, or test printing for controlling the image forming unit to form an image based on only a part of the image data, wherein the display is configured to display, in a case where the test printing has been executed, first information indicating that the test printing has been executed and second information indicating an inspection result obtained by inspecting an image formed in the test printing by the inspector.

Further features of the present invention will become apparent from the following description of exemplary embodiments (with reference to the attached drawings).

### BRIEF DESCRIPTION OF THE DRAWINGS

FIG. 1 is a configuration diagram of an image forming system.

FIG. 2 is a configuration diagram of a controller.

FIG. 3 is a configuration diagram of an inspection controller.

FIG. 4 is an explanatory view of an operation screen.

FIG. 5 is an explanatory view of an inspection setting screen.

FIG. 6 is an explanatory view of the operation screen during execution of an inspection.

FIG. 7A is an explanatory view of the operation screen during a main printing inspection.

FIG. 7B is an explanatory view of the operation screen during a test printing inspection.

FIG. 8 is a flow chart of main printing inspection processing.

FIG. 9 is a flow chart of test printing inspection processing.

FIG. 10 is an explanatory view of the operation screen.

FIG. 11 is an explanatory view of the operation screen in a third embodiment of the present disclosure.

FIG. 12 is an explanatory view of an inspection result detail screen.

### DESCRIPTION OF THE EMBODIMENTS

Now, embodiments of the present disclosure are described with reference to the accompanying drawings. Unless otherwise specified, the following embodiments can be freely combined. Further, those embodiments and modification examples thereof do not limit the disclosure according to the appended claims, and not all combinations of features described in the embodiments are necessarily essential to solving means for the disclosure.

### First Embodiment

### Configuration of Printing System

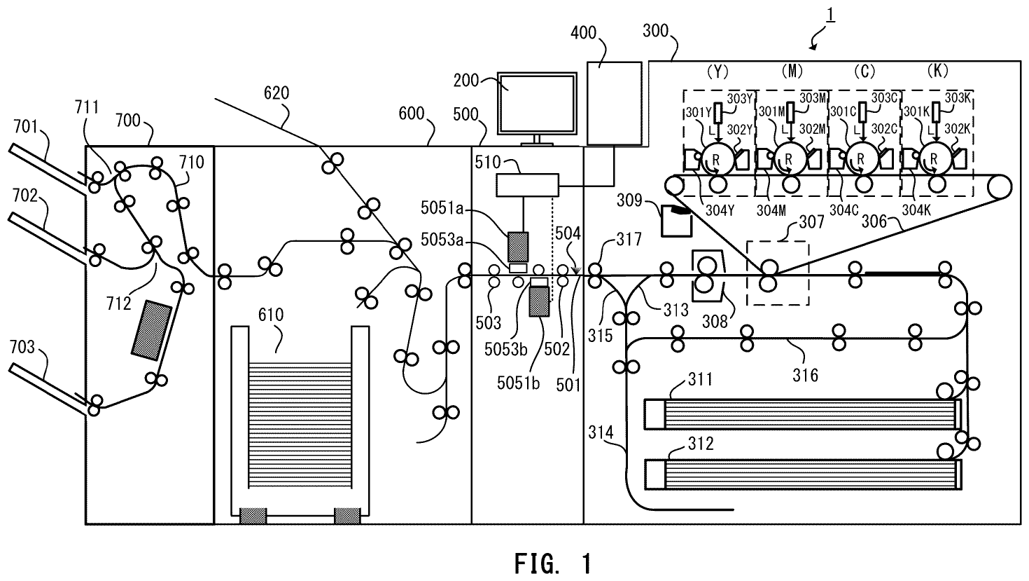

FIG. 1 is a configuration diagram of an image forming system including a printing inspection apparatus according to a first embodiment of the present disclosure. An image forming system 1 includes an operating device 200, a printer 300 serving as an image forming unit, a controller 400, an inspection apparatus 500 serving as an image inspector, a stacker 600, and a finisher 700 serving as a post-processor.

The operating device 200 is a user interface provided with an input interface and an output interface. The input interface is, for example, an input key and a touch panel. The output interface is, for example, a display and a speaker. Therefore, the operating device 200 functions as means for presenting information through vision and hearing. The operating device 200 transmits, to the controller 400, an instruction and data that have been input from the input interface. In addition, the operating device 200 outputs information from the output interface in response to an instruction received from the controller 400.

The controller 400 controls operations of the printer 300, the inspection apparatus 500, the stacker 600, and the finisher 700 based on instructions and data that have been input from the operating device 200 or instructions and data that have been acquired from an external apparatus through a network. For example, to perform image formation, the controller 400 transmits an instruction for the image formation to the printer 300. Details of the controller 400 are described later.

### Printer

The printer 300 in the first embodiment is a color image forming apparatus that prints a color image on a sheet, and functions as printing means. The printer 300 includes image forming units Y, M, C, and K, an intermediate transfer member 306, a transfer unit 307, a fixing device 308, sheet feeding cassettes 311 and 312, and a feeding mechanism for the sheet. The image forming unit Y forms an image of yellow (Y). The image forming unit M forms an image of magenta (M). The image forming unit C forms an image of cyan (C). The image forming unit K forms an image of black (K). The images of the respective colors formed by the image forming units Y, M, C, and K are transferred onto the intermediate transfer member 306 in a superimposed manner. The transfer unit 307 transfers the image borne on the intermediate transfer member 306 onto the sheet. The fixing device 308 fixes, to the sheet, the image transferred onto the sheet. The respective image forming units Y, M, C, and K have the same configuration, and form the images by the same operation. The following description is directed to a configuration of the image forming unit Y, and descriptions of configurations of the image forming units M, C, and K are omitted.

The image forming unit Y includes a photosensitive drum 301Y, a charger 302Y, an exposure device 303Y, and a developing device 304Y. The photosensitive drum 301Y is a drum-shaped photosensitive member including a photosensitive layer on a surface thereof. During an operation, the photosensitive drum 301Y is rotated in a direction indicated by an arrow R about a drum axis. The charger 302Y uniformly charges the surface of the photosensitive drum 301Y being rotated. The exposure device 303Y acquires image data representing an image of yellow from the controller 400, and emits and outputs a laser beam in accordance with the image data. The laser beam output from the exposure device 303Y scans the charged surface of the photosensitive drum 301Y in a drum axis direction.

The laser light scans the surface of the photosensitive drum 301Y being rotated, to thereby form an electrostatic latent image corresponding to the image data of yellow on the surface of the photosensitive drum 301Y. The developing device 304Y stores a yellow developer (e.g., toner), and uses the developer to develop the electrostatic latent image formed on the photosensitive drum 301Y. Thus, a yellow image is formed on the surface of the photosensitive drum 301Y. The developing device 304Y is configured so that a developer can be constantly supplied thereto from a toner cartridge (not shown).

In the same manner, a magenta image is formed on a photosensitive drum 301M of the image forming unit M. A cyan image is formed on a photosensitive drum 301C of the image forming unit C. A black image is formed on a photosensitive drum 301K of the image forming unit K. The intermediate transfer member 306 is an endless belt member, and is rotated in a clockwise direction in FIG. 1. The intermediate transfer member 306 is in contact with the respective photosensitive drums 301Y, 301M, 301C, and 301K. In accordance with the rotation of the intermediate transfer member 306, the images of the respective colors are transferred from the respective photosensitive drums 301Y, 301M, 301C, and 301K in order so as to be superimposed one on another. Thus, a full-color image is formed on the intermediate transfer member 306. The intermediate transfer member 306 conveys the full-color image borne thereon to the transfer unit 307 by being rotated.

Sheets are stored in each of the sheet feeding cassettes 311 and 312, and are conveyed from the sheet feeding cassettes 311 and 312 to the transfer unit 307 by the feeding mechanism. A sheet is conveyed in accordance with a timing at which the image borne on the intermediate transfer member 306 is conveyed to the transfer unit 307. The transfer unit 307 transfers the image from the intermediate transfer member 306 onto the sheet. A cleaner 309 is arranged on a downstream side of the transfer unit 307 in a rotation direction of the intermediate transfer member 306. The cleaner 309 removes a developer remaining on the intermediate transfer member 306 after the transfer.

The sheet onto which the image has been transferred is conveyed from the transfer unit 307 to the fixing device 308. The fixing device 308 includes a heater and a pressure roller. The fixing device 308 uses heat from the heater and pressure from the pressure roller to melt the image and fix the image to the sheet.

Conveying paths 313, 314, and 315, a duplex conveying path 316, and discharge rollers 317 are provided on a downstream side of the fixing device 308 in a conveying direction of the sheet. The sheet that has passed through the fixing device 308 is temporarily conveyed from the conveying path 313 to the conveying path 314. After a trailing end of the sheet has passed through the conveying path 313, the conveying direction is reversed to convey the sheet from the conveying path 315 to the discharge rollers 317. With such conveyance, the sheet is discharged from the printer 300 by the discharge rollers 317 with an image-formed side facing downward (face down). A printed matter, which is the sheet that has been subjected to the image formation and discharged from the printer 300 by the discharge rollers 317, is passed over to the inspection apparatus 500.

When duplex printing is to be performed on the sheet, the sheet conveyed to the conveying path 314 is conveyed to the duplex conveying path 316 after the trailing end has passed through the conveying path 313. The sheet is conveyed again to the transfer unit 307 through the duplex conveying path 316. Due to the passage through the duplex conveying path 316, a side of the sheet on which the image has been formed is turned over. The turned-over side is subjected to image transferring processing by the transfer unit 307 and fixing processing by the fixing device 308, to thereby form an image on this side. The sheet having images formed on both sides is discharged as a printed matter from the printer 300 by the discharge rollers 317, and is passed over to the inspection apparatus 500.

### Printing Inspection Apparatus

The inspection apparatus 500 includes a conveying path 501, an inspection controller 510, a first reader 5051a, a second reader 5051b, flow reading glasses 5053a and 5053b, conveying rollers 502 and 503 serving as conveying means, and a sheet detection sensor 504. Under the control of the controller 400, the inspection controller 510 controls the operation of the inspection apparatus 500. Details of the inspection controller 510 are described later. The first reader 5051a and the second reader 5051b are arranged at positions opposed to each other across the conveying path 501. The conveying rollers 502 and 503 convey the printed matter.

The inspection apparatus 500 detects the printed matter conveyed on the conveying path 501 by the sheet detection sensor 504, and the first reader 5051a and the second reader 5051b read the print images. The first reader 5051a and the second reader 5051b transmit reading results of the printed matter to the inspection controller 510. The inspection controller 510 performs a quality inspection of the images printed on the printed matter based on the reading results of the printed matter. The first reader 5051a and the second reader 5051b are arranged so as to be opposed to each other across the conveying path 501, and hence the images printed on both sides of the printed matter are read in one time of conveyance of the printed matter. The printed matter from which the images have been read is conveyed from the inspection apparatus 500 to the stacker 600.

### Stacker and Finisher

The stacker 600 includes a large-capacity tray 610 and a purge tray 620. The stacker 600 discharges a printed matter to any one of the large-capacity tray 610, the finisher 700, and the purge tray 620 based on an instruction received from the controller 400 and the results of the quality inspection performed by the inspection controller 510.

The finisher 700 includes a printed matter conveyor 710 including a plurality of conveying rollers and conveying paths, an upper-stage delivery tray 701, a middle-stage delivery tray 702, and a lower-stage delivery tray 703. The printed matter conveyor 710 includes switching mechanisms 711 and 712 for switching a discharge destination of the printed matter. The finisher 700 takes in printed matters from the stacker 600 in order, and discharges each of the printed matters to any one of the upper-stage delivery tray 701, the middle-stage delivery tray 702, and the lower-stage delivery tray 703 in response to an instruction received from the controller 400. The finisher 700 may be configured to perform post-processing, such as staple processing for binding and stapling a plurality of printed matters, bookbinding processing for the bound printed matters, and cut-off processing for the bound printed matters.

### Controller

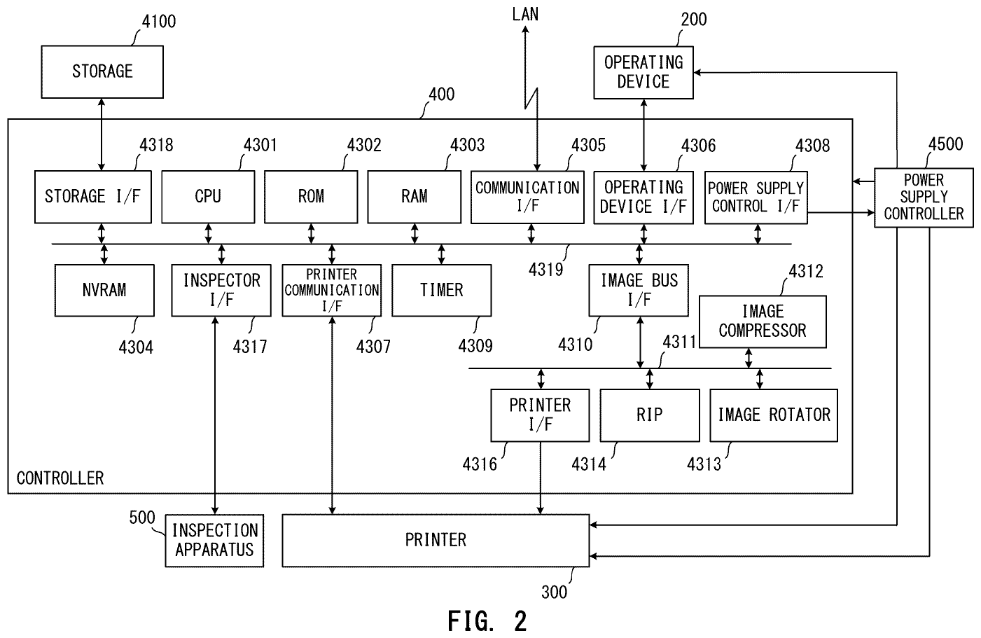

FIG. 2 is an explanatory diagram of a configuration of the controller 400. In addition to the printer 300, the inspection apparatus 500, and the operating device 200, the controller 400 is connected to a storage 4100 and a power supply controller 4500. The storage 4100 is a large-capacity storage device, such as a hard disk drive (HDD) or a solid state drive (SSD). As interfaces with the respective components to be connected, the controller 400 includes a storage I/F 4318, an operating device I/F 4306, a power supply control I/F 4308, an inspector I/F 4317, a printer communication I/F 4307, and a printer I/F 4316. The controller 400 also includes a communication I/F 4305 for communicating to/from an external apparatus through the network. The storage I/F 4318, the operating device I/F 4306, the power supply control I/F 4308, the inspector I/F 4317, the printer communication I/F 4307, and the communication I/F 4305 are connected to a system bus 4319.

The controller 400 includes a central processing unit (CPU) 4301, a read only memory (ROM) 4302, and a random access memory (RAM) 4303. The CPU 4301 executes a computer program stored in the ROM 4302 to control an operation of the image forming system 1. The RAM 4303 provides a work area for the CPU 4301 to execute processing. The RAM 4303 is also used as an image memory for temporarily storing image data and the like. The CPU 4301, the ROM 4302, and the RAM 4303 are also connected to the system bus 4319. A non-volatile RAM (NVRAM) 4304 and a timer 4309 are also connected to the system bus 4319. The NVRAM 4304 stores various parameters for control. The timer 4309 holds a current time, and monitors passage of a set time period.

The operating device I/F 4306 controls communication to/from the operating device 200. The operating device I/F 4306 receives input of print jobs, commands, and printing settings, which is performed from the operating device 200 to the controller 400, and transmits the input information to the CPU 4301. Under the control of the CPU 4301, the operating device I/F 4306 displays various screens and states of the image forming system 1 on a display of the operating device 200. Under the control of the CPU 4301, the printer communication I/F 4307 controls communication to/from the printer 300. The power supply control I/F 4308 instructs the power supply controller 4500 to supply or stop various kinds of electric power in accordance with a command received from the CPU 4301. The power supply controller 4500 supplies electric power to the printer 300. Under the control of the CPU 4301, the inspector I/F 4317 controls communication to/from the inspection apparatus 500. Under the control of the CPU 4301, the storage I/F 4318 controls communication to/from the storage 4100. The storage 4100 is a large-capacity storage device, such as a hard disk drive (HDD) or a solid state drive (SSD).

The communication I/F 4305 is connected to a network such as a local area network (LAN), and performs communication control, such as transmission and reception of an email and inputting and outputting of PDL data from an external apparatus. The communication I/F 4305 also includes an NVRAM (not shown), and holds various parameters relating to communication control, such as a MAC address.

The system bus 4319 is connected to an image bus 4311 through an image bus I/F 4310. The image bus I/F 4310 is a bridge that connects the system bus 4319 and an image bus 4311 for transferring image data to the printer 300 to each other. A printer I/F 4316, an image compressor 4312, an image rotator 4313, and a raster image processor (RIP) 4314 are connected to the image bus 4311.

The image compressor 4312 performs compression and decompression processing for JPEG, JBIG, MMR, MH, and the like. The image rotator 4313 performs image rotation processing. The RIP 4314 expands PDL code into a bitmap raster image. The printer I/F 4316 transmits image data to the printer 300. This image data is generated by the controller 400 subjecting image data for print output to image processing for the printer 300, such as correction for the printer 300 and resolution conversion.

### Inspection Controller

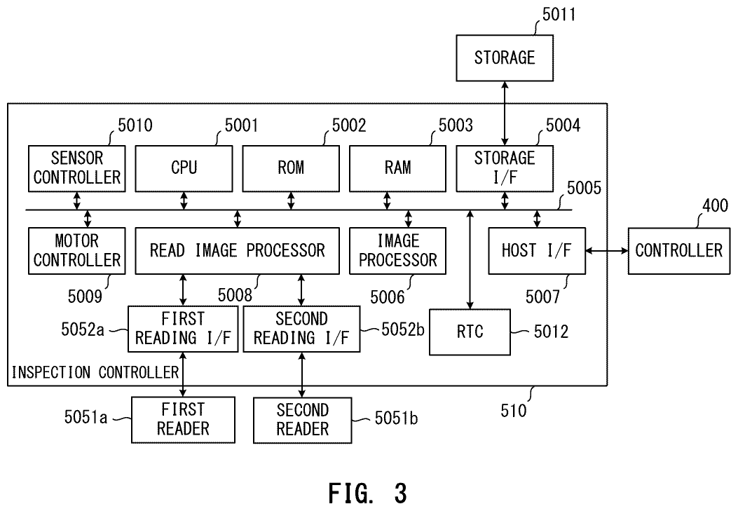

FIG. 3 is an explanatory diagram of a configuration of the inspection controller 510 provided to the inspection apparatus 500. The inspection controller 510 controls operations of the first reader 5051a and the second reader 5051b. The inspection controller 510 performs processing, such as analysis of the reading results from the first reader 5051a and the second reader 5051b, operation control of the inspection apparatus 500, and communication to/from the controller 400. The inspection controller 510 is also connected to a storage 5011, which is storage means for storing a misregistration correction profile and the like, and the controller 400.

The inspection controller 510 includes a CPU 5001, a ROM 5002, a RAM 5003, a storage I/F 5004, a motor controller 5009, a read image processor 5008, an image processor 5006, an RTC 5012, a host I/F 5007, and a sensor controller 5010. The respective components are connected to a system bus 5005. The read image processor 5008 is connected to the first reader 5051a through a first reading I/F 5052a, and is connected to the second reader 5051b through a second reading I/F 5052b. The RTC 5012 is a real-time clock, and holds the current time with high accuracy.

The host I/F 5007 controls communication to/from the inspector I/F 4317 of the controller 400. When the inspection controller 510 and the controller 400 communicate to/from each other, data is transmitted and received between the host I/F 5007 and the inspector I/F 4317. For example, the host I/F 5007 acquires image data used for an image forming operation of the printer 300 from the controller 400. The storage 5011 is a large-capacity storage device, such as an HDD or an SSD. The image data can be stored in any location, but is stored in the storage 5011 in the first embodiment.

The CPU 5001 executes a computer program stored in the ROM 5002 to control the operation of the inspection apparatus 500. The RAM 5003 provides a work area for the CPU 5001 to execute processing. The storage I/F 5004 controls communication to/from the storage 5011 connected to the inspection controller 510.

The read image processor 5008 is controlled by the CPU 5001 to acquire the reading result of the image on the printed matter from the first reader 5051a through the first reading I/F 5052a. The read image processor 5008 is also controlled by the CPU 5001 to acquire the reading result of the image on the printed matter from the second reader 5051b through the second reading I/F 5052b. Under the control of the CPU 5001, the read image processor 5008 performs magnification processing, gamma correction processing, and the like on the reading results (read data) of the images on the printed matter, which have been acquired from the first reader 5051a and the second reader 5051b, to generate read image data, and stores the read image data in the RAM 5003. The first reader 5051a and the second reader 5051b are each provided with a sensor array, and are each capable of reading an entire region of the printed matter conveyed on the conveying path 501. The first reader 5051a reads an image on a first side of a printed matter, and the second reader 5051b reads an image on a second side of the printed matter.

The first reader 5051a and the second reader 5051b are each formed of a light emitter and a light receiver. The light emitter is formed of, for example, a white light emitting diode (LED), and the light receiver is formed of, for example, a CMOS sensor equipped with an RGB color filter. The light emitter is controlled by the CPU 5001 to irradiate the printed matter being conveyed along the conveying path 501 with light. The light receiver receives the light reflected by the printed matter by separating the light into three color components of RGB through use of a color filter, and outputs read data as a light reception result (reading result). The read data is transmitted to the read image processor 5008.

Under the control of the CPU 5001, the motor controller 5009 controls operations of various motors provided in the inspection apparatus 500. Under the control of the CPU 5001, the sensor controller 5010 controls the operations of various sensors provided in the inspection apparatus 500, and notifies the CPU 5001 of detection results from the sensors. The image processor 5006 is controlled by the CPU 5001 to compare the image data stored in the storage 5011 (hereinafter referred to as “reference image data”) to the read image data stored in the RAM 5003, to thereby perform a quality inspection of the printed matter. The reference image data is image data to be used by the printer 300 forming an image, and is stored in the storage 5011. In another case, the reference image data may be an image obtained by reading a reference image in advance before the quality inspection is performed. During the comparison, the image processor 5006 subjects the reference image data to correction processing using a parameter based on calibration described later.

### Printing Settings

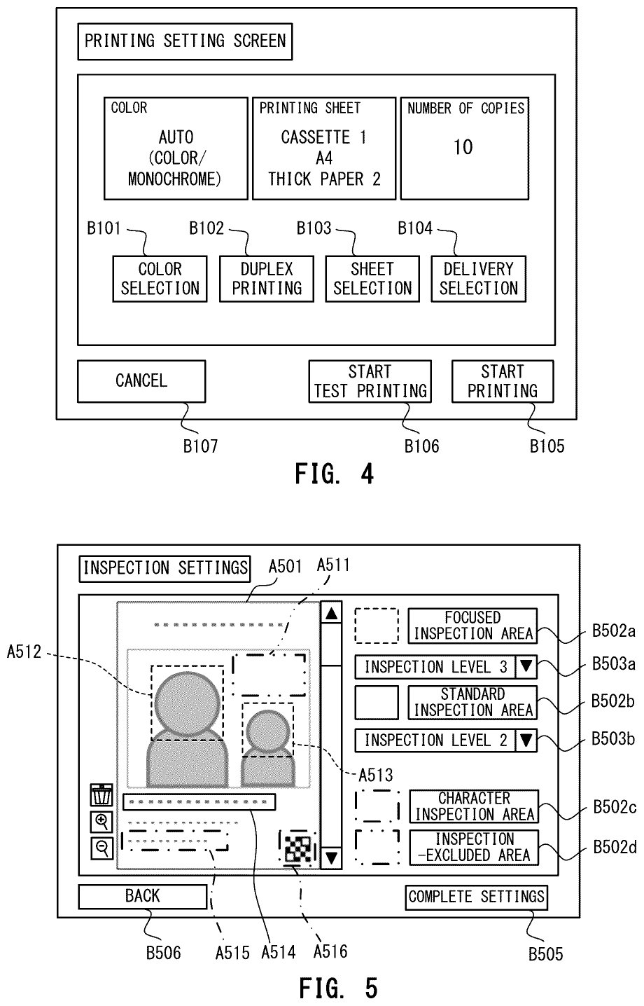

FIG. 4 is an explanatory view of an operation screen displayed on the display of the operating device 200 in order to instruct the printer 300 to perform printing. The operation screen functions as an information presentation screen for presenting information such as printing settings, and a user causes the printer 300 to execute printing through use of such an operation screen displayed on the display. FIG. 4 indicates a state in which selection of color or monochrome is set to automatic selection, a cassette 1 is selected as a cassette for use, A4 is selected as a sheet size, thick paper 2 is selected as a type of paper, and 10 copies are selected as the number of copies to be printed. A button B101 to a button B104 are buttons for providing respective printing settings. The button B101 is a button for selecting the color (color or monochrome) for printing, and the button B102 is a button for selecting a printing side (simplex printing or duplex printing). The button B103 is a sheet selection button for selecting a type of sheet, and the button B104 is a delivery selection button for setting, for example, the discharge destination of the printed matter. In addition, the number of copies to be printed can be set through use of a numeric keypad (not shown). A button B105 is a printing start button, and when the button B105 is pressed, printing is started with the printing settings provided by the button B101 to the button B104 and the number of copies set by the numeric keypad, that is, main printing is started. A button B106 is a test printing start button, and when the button B106 is pressed, only one copy of the first page is printed with the printing settings provided by the button B101 to the button B104.

In the first embodiment, and second and third embodiments of the present disclosure, not printing pages to be printed the number of which is specified through the operation screen as they are but printing some of the pages (for example, only one page) is described as test printing, and printing the pages the number of which is designated is described as main printing. However, even when all pages are to be printed, a case of printing fewer copies than a specified plurality of number of copies to be printed (for example, printing only one copy when a plurality of copies are required) in order to check a printing result may also be included in the “test printing.” Further, performing printing with the number of pages or the number of copies different from the designated number of pages or the designated number of copies for some purpose such as checking the printing result may be included in the “test printing.”

The inspection apparatus 500 executes the inspection of the printed matter in accordance with inspection settings provided in advance. The central processing unit (CPU) 4301 of the controller 400 functions as control means. Irrespective of which of the button B105 and the button B106 is pressed, the CPU 4301 controls the inspection apparatus 500 to execute the inspection of the printed matter in accordance with the inspection settings provided in advance. When a button B107, which is a cancel button, is pressed, the settings that have been input by the user are canceled, and a predetermined initial screen is displayed on the display of the operating device 200.

In addition, a no-inspection-required button (not shown) for receiving an operation for omitting (eliminating requirement of) the inspection of the printed matter in the main printing may be further provided separately from the button B101 to the button B107. In this case, in a case in which the omission of the inspection has been selected by the no-inspection-required button, the inspection of the printed matter is executed by the inspection apparatus 500 only when the test printing is executed, while the inspection of the printed matter is not executed when the main printing is performed. Through provision of such a button, for example, when the user has determined that the inspection settings are correctly provided and the inspection of the printed matter is not required, it is possible to quickly execute the main printing without performing the inspection of the printed matter. It is also possible to improve productivity by executing the inspection of the printed matter in both the main printing and the test printing and by enabling selective inspection of the printed matter only in the test printing when the user has determined that the inspection of the printed matter is not required.

### Inspection Settings

FIG. 5 is an explanatory view of an inspection setting screen for providing the inspection settings of the inspection apparatus 500. The inspection setting screen has a function serving as reception means for receiving an instruction from the user for setting an inspection area in which an inspection such as a quality inspection is to be executed by the inspection apparatus 500. In FIG. 5, an area A501 is a printed-image and inspection-setting-area display portion, and the inspection area can be freely set through use of a mouse, a touch panel, or the like. In this example, an original image in a print job is displayed in the area A501, and an area A511 to an area A516 are illustrated as inspection areas. The area A501 and the area A511 to the area A516 are each a rectangular region, but any shape, such as a triangle, a polygon, or a circle, may be able to be designated in accordance with a shape of an area to be inspected.

A button B502a to a button B502d are buttons for setting an inspection area type. The user can set the inspection area by selecting an image display area in the area A501 with each of the button B502a to the button B502d being selected. In FIG. 5, four types of buttons are illustrated for setting the inspection area type. The button B502a is a focused inspection area button for setting an area in which a highly accurate inspection is to be performed, and the button B502b is a standard inspection area button for setting an overall inspection level. In addition, the button B502c is a detailed setting button for providing detailed settings regarding a variable inspection area that is an area in which a variable inspection is to be performed. The variable inspection area is an area within the entire print image in which information is replaced for each sheet or each recording medium, and for example, a number, a barcode, or the like that differs for each sheet is formed in the variable inspection area. It can be determined whether or not there is an abnormality in the image based on whether or not the information indicated by a reading result of the variable inspection area has consistency that follows a predetermined rule, for example, an ascending order or a descending order of numbers. In the example of FIG. 5, a state in which a character inspection area has been selected as the variable inspection area is illustrated. In addition, in the example of FIG. 5, the character inspection area is an area for inspecting not only a character string but also a two-dimensional code and a barcode. The button B502d is an inspection-excluded area button for designating an area in which an inspection is not to be performed.

In the example of FIG. 5, an inspection level setting button for setting an inspection level in terms of inspection accuracy stepwise, for example, from a level 1 to a level 5, is provided for each inspection area type. Specifically, a button B503a is provided as an inspection level setting button for the button B502a that is the focused inspection area. In addition, a button B503b is provided as an inspection level setting button for the button B502b that is the standard inspection area. This allows the user to set the inspection level for each of the focused inspection area of the button B502a and the standard inspection area of the button B502b. In the example of FIG. 5, an inspection level 1 has the lowest inspection accuracy, and the inspection accuracy increases as an inspection level number increases. In the example of FIG. 5, an inspection level 3 is set as the inspection level for the focused inspection area, and an inspection level 2 is set as the inspection level for the standard inspection area.

A button B505 is a setting completion button, and when the user selects and presses this button, the inspection settings are completed. The inspection may be automatically started when the user presses the button B505 to complete the inspection settings. A button B506 is a button for returning to the previous screen, and when the user selects this button, inspection setting processing is canceled to return to a predetermined initial screen. In addition, a dotted-line rectangle is shown on the left side of the button B502a representing the focused inspection area, and it is visually shown that the focused inspection area is represented by a dotted-line rectangle within the area A501. In the same manner, a solid-line rectangle is shown on the left side of the button B502b representing the standard inspection area, and the standard inspection area is represented by a solid-line rectangle within the area A501. A one-dot-chain-line rectangle is shown on the left side of the button B502c representing the character inspection area, and the character inspection area is represented by a one-dot-chain-line rectangle within the area A501. A two-dot-chain-line rectangle is shown on the left side of B502d representing an inspection-excluded area, thus the inspection-excluded area is represented by a two-dot-chain-line rectangle within the area A501.

For example, the user can freely select an area to be subjected to a focused inspection by selecting the button B502a and selecting, through use of a mouse or the like, an area within the area A501 in which a focused inspection is required to be performed. In the example of FIG. 5, the areas A512 and A513, which are areas including human faces, are both represented by dotted-line rectangles, and those areas are shown as the focused inspection areas set by the button B502a. The area A514 is represented by a solid-line rectangle, and is shown as the standard inspection area set by the button B502b. The area A515 and the area A516 are both represented by one-dot-chain-line rectangles, and are shown as the character inspection areas for inspecting a character string, a two-dimensional code, and a barcode which are set by the button B502c. In the example of FIG. 5, the area A515 is an area including a character string, and the area A516 is an area including a two-dimensional code. The area A511, which is a background region and is not required to be subjected to a highly accurate inspection, is represented by a two-dot-chain-line rectangle, and is shown as the inspection-excluded area set by the button B502d.

Compared to a case of inspecting an entire image, only required areas can be selected to be inspected, to thereby be able to reduce resources required for the inspection, for example, a use amount of the RAM 5003 of the inspection apparatus 500 and a load and throughput for processing performed on the CPU 5001. In addition, through setting of the inspection level stepwise, for example, from the level 1 to the level 5, resources of an image forming apparatus required for the inspection can be reduced compared to a case of constantly performing the inspection at a high level of inspection accuracy. Further, through setting of a plurality of areas and setting of the inspection level for each of the areas, the resources can be optimally allocated in accordance with the required level of inspection accuracy.

### Printing Inspection during Test Printing

The test printing is used for checking whether or not the print image, the printing settings of the printer 300, and the inspection settings of the inspection apparatus 500 are correct.

For example, when a print image includes a character string and the user wishes to inspect whether or not the printed character string is correct through use of the inspection apparatus 500, the user sets a character string area by the above-mentioned method. The inspection apparatus 500 performs optical character recognition (OCR) processing on the print image in the set area. However, when the setting of the area set by the user is incorrect, an inspection result is unacceptable (NG). Examples thereof include a case in which an area other than a character string is set as the inspection area for a character string and a case in which a part of a character string is not included in the area set by the user. In the following description, the fact that an inspection result or the like is unacceptable is simply referred to as “inspection NG” or the like.

Further, when the inspection level set by the user is different from the inspection accuracy intended by the user, “inspection NG” may be determined even within a range that is considered to be acceptable by the user. When, for example, the set inspection level is stricter than the inspection accuracy intended by the user, “inspection NG” may be determined against such an intention of the user. When the main printing is executed under such a state as described above, there is a possibility that the number of sheets that are determined as “inspection NG” may increase. In addition, in a case in which the inspection result is unacceptable in the main printing and recovery printing is executed, when there is a setting error, a situation in which the inspection result is unacceptable occurs repeatedly, which leads to wasteful paper consumption and increasing apparatus downtime. At the time of execution of the test printing, recovery printing is not executed even when the inspection result is unacceptable, and the inspection apparatus 500 notifies, through the operating device 200, the user whether or not there is an error in the inspection settings.

### Description of Inspection Execution Screen of Operating Device

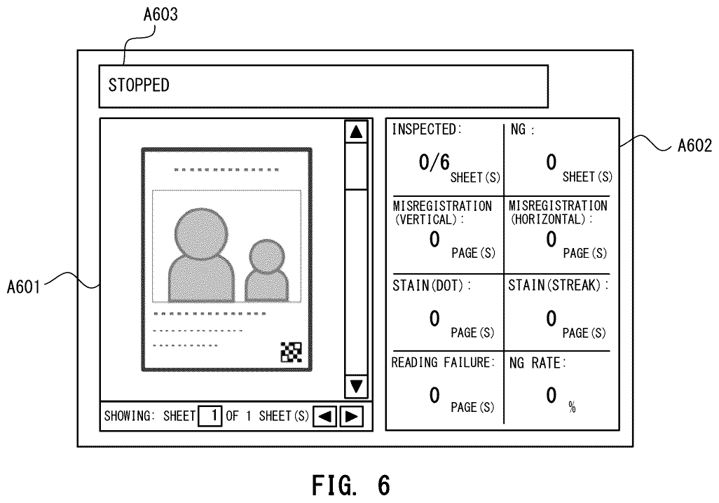

FIG. 6 is an explanatory view of the operation screen during execution of an inspection in the first embodiment. In FIG. 6, an area A601 is an area for displaying a read image. An area A602 is an area for displaying inspection statuses, such as a completed inspection count, an inspection NG count, an inspection NG rate, and a type of NG. An area A603 is an area for displaying a status, such as waiting, inspecting, or inspection completed. In FIG. 6, “STOPPED” indicating that the inspection is temporarily stopped is displayed in the area A603.

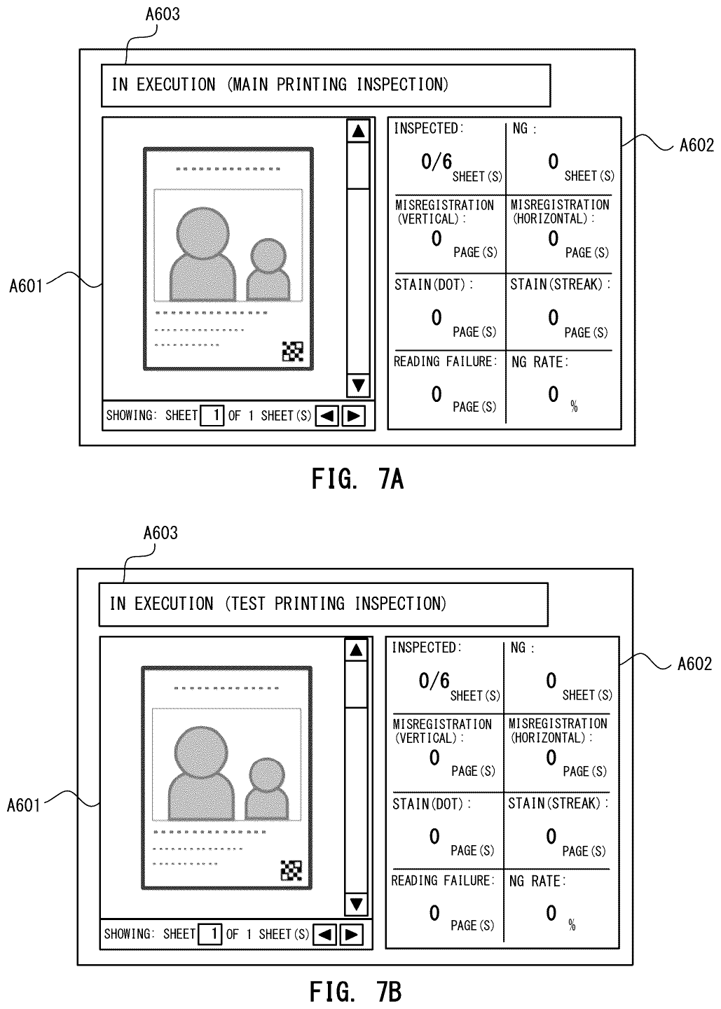

FIG. 7A is an explanatory view of the operation screen displayed when the printer 300 is executing a main printing inspection, and FIG. 7B is an explanatory view of the operation screen displayed when the printer 300 is executing a test printing inspection. When the inspection apparatus 500 is executing a main printing inspection, as illustrated in FIG. 7A, “IN EXECUTION (MAIN PRINTING INSPECTION)” indicating that the main printing inspection is being executed is displayed in the area A603. When the printer 300 has executed test printing and the inspection apparatus 500 is executing an inspection, as illustrated in FIG. 7B, “IN EXECUTION (TEST PRINTING INSPECTION)” indicating that the test printing inspection is being executed is displayed in the area A603.

As described above, the user can easily check the type of inspection being executed (for example, test printing inspection, main printing inspection, or inspection stopped) by checking an item described in the status display area of the area A603 on an operating device screen during execution of an inspection. In particular, there is a possibility that the user may forget whether a test printing inspection or a main printing inspection is being performed, and hence it is useful to be able to check the type of inspection currently being performed. Further, even a user other than the user who has input a print job from the operating device 200 to the controller 400 can check the type of inspection currently being performed by checking the item described in the status display area.

### Main Printing Inspection Processing Flow

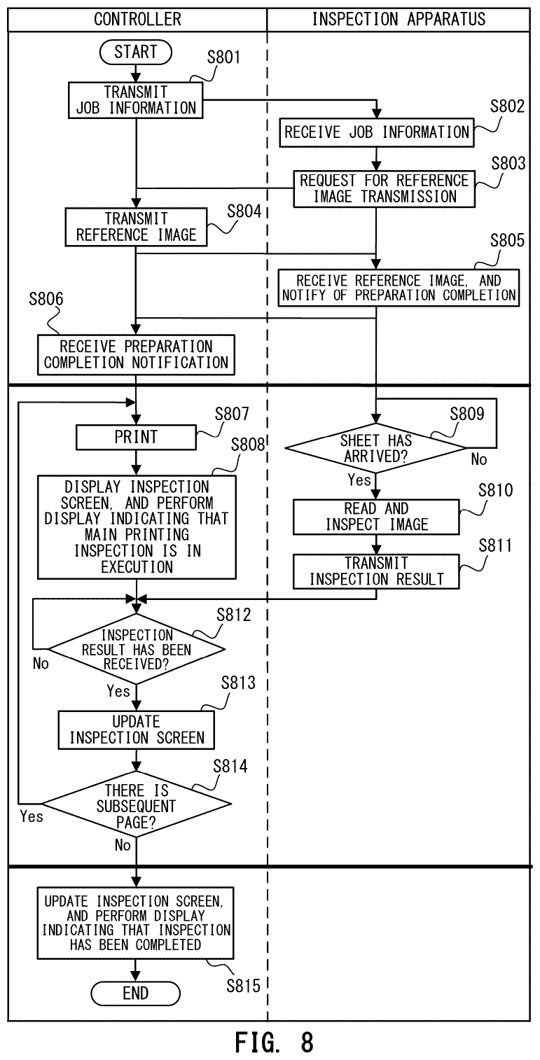

FIG. 8 is a flow chart of main printing inspection processing. In this flow chart, processing to be executed by the CPU 4301 of the controller 400 and processing to be executed by the CPU 5001 of the inspection apparatus 500 are collectively illustrated. In FIG. 4, when the user selects and presses the button B105, which is the printing start button, the CPU 4301 is instructed to execute the main printing, and the main printing inspection processing is executed in accordance with the instruction.

When the button B105 is selected through the operating device 200, the CPU 4301 of the controller 400 transmits, to the inspection apparatus 500, job information including, for example, sheet information for use in printing, inspection settings, and a discharge destination (Step S801).

The CPU 5001 of the inspection apparatus 500 receives the job information from the controller 400 (Step S802). After having received the job information from the controller 400, the CPU 5001 of the inspection apparatus 500 transmits, to the controller 400, a reference image transmission request for inspection determination (Step S803).

The CPU 4301 of the controller 400 transmits original image data of the print job as reference image data to the inspection apparatus 500 based on the reference image transmission request received from the inspection apparatus 500 (Step S804). The CPU 5001 of the inspection apparatus 500 receives the reference image from the controller 400 to store the reference image in the storage 5011, and notifies the controller 400 of completion of preparation for the print job (Step S805).

When the CPU 4301 of the controller 400 receives a preparation completion notification from the inspection apparatus 500 (Step S806), the CPU 4301 controls the printer 300 to start the printing (Step S807). After that, the CPU 4301 controls the operating device 200 to display an inspection screen, and performs display indicating that the main printing inspection is in execution on the inspection screen as illustrated by the area A603 of FIG. 7A (Step S808). The present disclosure is not limited to this example, and, for example, the CPU 4301 may perform display indicating that the main printing inspection is to be started on the inspection screen when the preparation completion notification is received from the inspection apparatus 500, and may perform display indicating that the main printing inspection is in execution after a lapse of a predetermined time period. In this case, until the above-mentioned predetermined time period has elapsed, a cancel button for the main printing inspection may be displayed on the screen together with the display indicating that the main printing inspection is to be started, and the user may be allowed to cancel the main printing inspection by pressing this cancel button.

After execution of Step S805, the CPU 5001 of the inspection apparatus 500 uses the sheet detection sensor 504 to determine whether or not a sheet has arrived at a sheet detection position of the sheet detection sensor 504 on the conveying path 501 of the inspection apparatus 500 (Step S809). When a sheet has not arrived (No in Step S809), the CPU 5001 of the inspection apparatus 500 waits for a sheet to arrive. When a sheet has arrived (Yes in Step S809), the CPU 5001 of the inspection apparatus 500 reads the sent sheet by the first reader 5051a and the second reader 5051b, and instructs the image processor 5006 to perform processing for comparison to the reference image data received in Step S805. Accordingly, the image processor 5006 performs the processing for comparison to perform an image inspection (Step S810).

The CPU 5001 of the inspection apparatus 500 transmits an inspection result of the image inspection based on the comparison performed by the image processor 5006 to the controller 400 (Step S811). The CPU 4301 of the controller 400 determines whether or not the inspection result has been received (Step S812). When the inspection result has not been received (No in Step S812), the CPU 4301 waits for reception of the inspection result, and when the inspection result has been received (Yes in Step S812), the CPU 4301 controls the operating device 200 to update the inspection screen based on the inspection result (Step S813).

After that, the controller 400 determines whether or not there is a page subsequent to the current page (Step S814), and when there is a subsequent page (Yes in Step S814), the controller 400 and the inspection apparatus 500 repeat the processing steps of from Step S807 to Step S814 again. When there is no subsequent page (No in Step S814), the CPU 4301 of the controller 400 determines that a final page of the job has been processed and the printing and inspection of all pages have been completed. Therefore, the CPU 4301 of the controller 400 controls the operating device 200 to perform display indicating that the inspection has been completed on the inspection screen (Step S815). Thus, the main printing inspection processing is ended.

### Test Printing Inspection Processing Flow

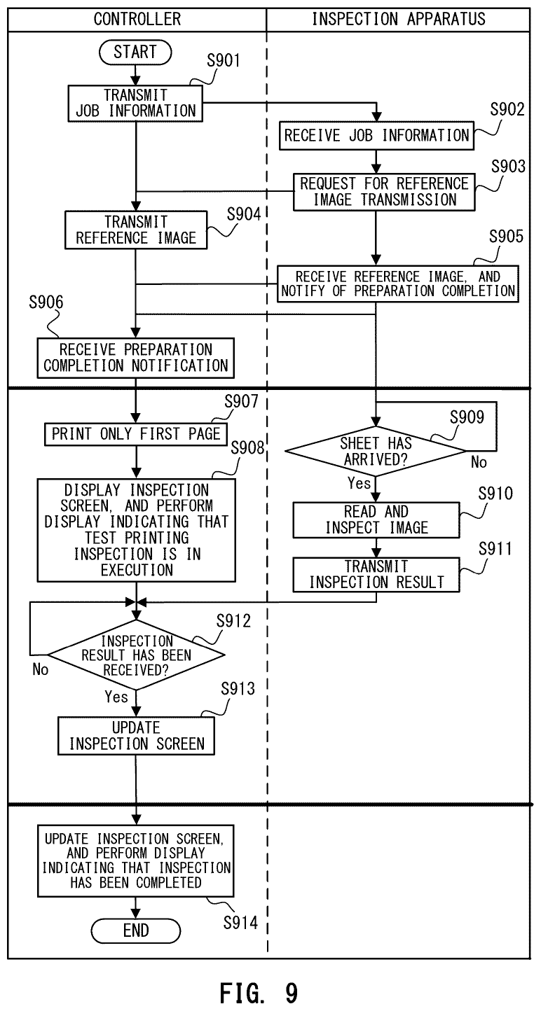

FIG. 9 is a flow chart of test printing inspection processing. In this control, processing to be executed by the CPU 4301 of the controller 400 and processing to be executed by the CPU 5001 of the inspection apparatus 500 are collectively illustrated. In FIG. 4, when the user selects the button B106, which is the test printing start button, the CPU 4301 is instructed to execute the test printing, and the test printing inspection processing is executed in accordance with the instruction.

When the button B106 is selected through the operating device 200, the CPU 4301 of the controller 400 transmits, to the inspection apparatus 500, job information including sheet information for use in printing, inspection settings, and a discharge destination (Step S901). The CPU 5001 of the inspection apparatus 500 receives the job information from the controller 400 (Step S902). After having received the job information from the controller 400, the CPU 5001 of the inspection apparatus 500 transmits, to the controller 400, a reference image transmission request for inspection determination (Step S903).

The CPU 4301 of the controller 400 transmits original image data of the print job as reference image data to the inspection apparatus 500 based on the reference image transmission request received from the inspection apparatus 500 (Step S904). The CPU 5001 of the inspection apparatus 500 receives the reference image from the controller 400 to store the reference image in the storage 5011, and notifies the controller 400 of completion of preparation for the print job (Step S905).

When the CPU 4301 of the controller 400 receives a preparation completion notification from the inspection apparatus 500 (Step S906), the CPU 4301 controls the printer 300 to start the printing of only the first page (Step S907). After that, the CPU 4301 controls the operating device 200 to display an inspection screen, and performs display indicating that the test printing inspection is in execution on the inspection screen as illustrated by the area A603 of FIG. 7B (Step S908). The present disclosure is not limited to this example, and, for example, the CPU 4301 may perform display indicating that the test printing inspection is to be started on the inspection screen when the preparation completion notification is received from the inspection apparatus 500, and may perform display indicating that the test printing inspection is in execution after a lapse of a predetermined time period. In this case, until the above-mentioned predetermined time period has elapsed, a cancel button for the test printing inspection may be displayed on the screen together with the display indicating that the test printing inspection is to be started, and the user may be allowed to cancel the test printing inspection by pressing this cancel button.

After execution of Step S905, the CPU 5001 of the inspection apparatus 500 uses the sheet detection sensor 504 to determine whether or not a sheet has arrived at a sheet detection position of the sheet detection sensor 504 on the conveying path 501 of the inspection apparatus 500 (Step S909). When a sheet has not arrived (No in Step S909), the CPU 5001 of the inspection apparatus 500 waits for a sheet to arrive. When a sheet has arrived (Yes in Step S909), the CPU 5001 of the inspection apparatus 500 sequentially reads the sent sheet by the first reader 5051a and the second reader 5051b, and instructs the image processor 5006 to perform processing for comparison to the reference image data received in Step S905. Accordingly, the image processor 5006 performs the processing for comparison to perform an image inspection (Step S910).

The CPU 5001 of the inspection apparatus 500 transmits an inspection result of the image inspection based on the comparison performed by the image processor 5006 to the controller 400 (Step S911). The CPU 4301 of the controller 400 determines whether or not the inspection result has been received (Step S912). When the inspection result has not been received (No in Step S912), the CPU 4301 waits for reception of the inspection result, and when the inspection result has been received (Yes in Step S912), the CPU 4301 controls the operating device 200 to update the inspection screen based on the inspection result (Step S913). After that, the CPU 4301 of the controller 400 controls the operating device 200 to perform display indicating that the inspection has been completed on the inspection screen (Step S914). Thus, the test printing inspection processing is ended.

### Second Embodiment

Now, the second embodiment of the present disclosure is described with reference to the accompanying drawing. In the second embodiment, all the apparatus components are the same as those in the first embodiment, and the second embodiment only differs from the first embodiment in the operating device screen for printing settings for executing the test printing and a processing operation of the inspection apparatus 500. Therefore, in the second embodiment described below, only the differences from the first embodiment are described.

### Printing Settings

FIG. 10 is an explanatory view of the operation screen displayed on the display of the operating device 200 when the printer 300 is instructed to perform printing. The user causes the printer 300 to execute printing through use of such an operation screen displayed on the display.

In the same manner as in the first embodiment, the button B101 to the button B104 are buttons for setting items of printing. The button B101 is a button for selecting the color (color or monochrome) for printing, and the button B102 is a button for selecting the printing side (one side or both sides). The button B103 is a button for selecting the type of sheet, and the button B104 is a button for setting, for example, the discharge destination of the printed matter. In addition, the number of copies to be printed can be set through use of a numeric keypad (not shown). In the same manner as in the first embodiment, the button B107 is a cancel button.

A button B108 is a test printing setting button for setting whether or not the test printing is to be executed, and a button B109 is a printing start button. When the button B109, which is the printing start button, is pressed under a state in which it is set by the button B108 that the test printing is not to be executed, the main printing is executed, and all pages are printed. However, when the button B109, which is the printing start button, is pressed under a state in which it is set by the button B108 that the test printing is to be executed, the test printing for printing only one copy of the first page with the printing settings provided by the button B101 to the button B104 is executed.

The inspection apparatus 500 carries out the inspection of the printed matter in accordance with the inspection settings provided in advance, irrespective of whether or not the test printing has been set by the button B108. When the button B107 is pressed, the settings that have been input by the user are canceled, and a predetermined initial screen is displayed on the display of the operating device 200.

### Third Embodiment

Now, the third embodiment for carrying out the present disclosure is described with reference to the accompanying drawings. In the third embodiment, apparatus components thereof are all the same as those in the first embodiment, and are therefore omitted. In the first embodiment, the display on the operating device screen at the time of execution of an inspection has been described, while in the third embodiment, items thereof relating to display of the inspection result on the operating device screen after the inspection are described.

### Description of Inspection Result List Screen of Operating Device

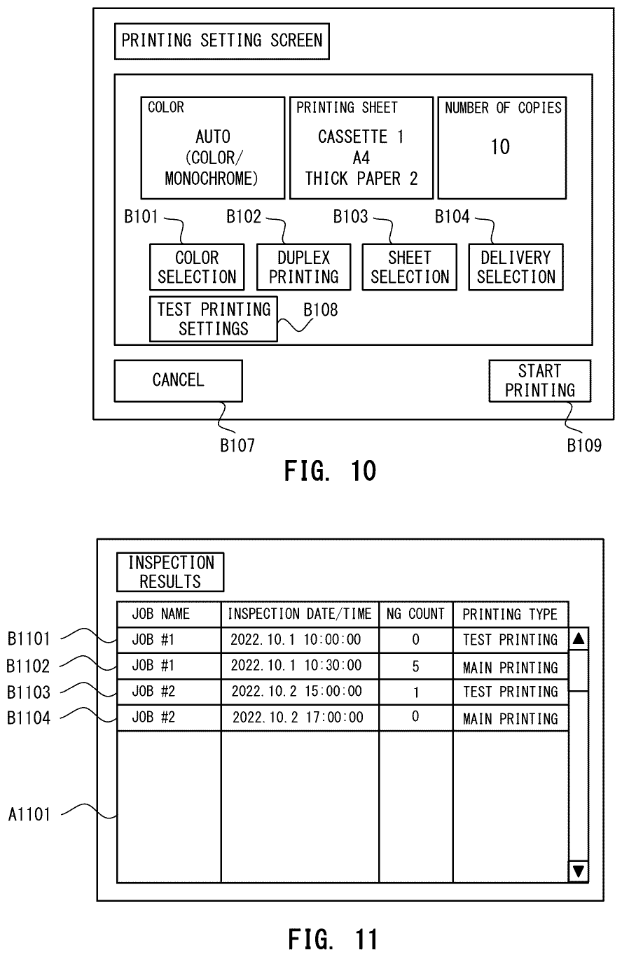

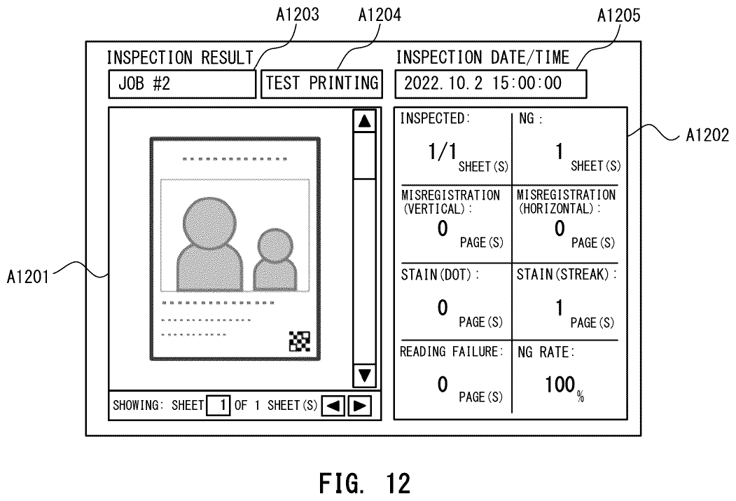

FIG. 11 is an explanatory view of the operating device screen displayed after completion of the inspection in the third embodiment. As illustrated in FIG. 11, on the operating device screen after the completion of the inspection, a list of inspection results is displayed as inspection result information. In FIG. 11, the area A1101 is an area for displaying, in a list, printing types and inspection results in completed inspections. The printing type indicates whether each print job is main printing or test printing. In this example, in the area A1101, the printing type is displayed, and a job name, inspection date and time, and the inspection NG count are displayed as information indicating the items of the inspection. However, the present disclosure is not limited thereto, and another item of the inspection may be displayed.

In the example of FIG. 11, the job name, the inspection date and time, the inspection NG count, and the printing type are displayed on one button. For example, on a button B1101 representing a first inspection result, “JOB #1” is displayed as the job name, “2022 Oct. 1 10:00:00” is displayed as the inspection date and time, “0” is displayed as the NG count (number of inspection defects), and “TEST PRINTING” is displayed as the printing type. In the same manner, on each of a button B1102 to a button B1104 representing second to fourth inspection results, respectively, the job name, the inspection date and time, the inspection NG count, and the printing type are displayed. When a button corresponding to a desired inspection result is pressed by being selected from among the button B1101 to the button B1104 that are displayed in the area A1101, a screen for showing detailed information on the relevant inspection result information is displayed.

FIG. 12 is an explanatory view of the screen for showing the detailed information on the inspection result information, which is displayed when the button B1103 representing the third inspection result is pressed in FIG. 11. In this detailed screen, an area A1201 is an area for displaying a read image. An area A1202 is an area for displaying the inspection statuses, such as the completed inspection count, the inspection NG count, the inspection NG rate, and the type of NG. In this example, it is shown that the number of inspected sheets is one while the total number of sheets is one (“INSPECTED: 1/1 SHEET(S)”), the number of NG sheets is “1”, the NG count due to a stain (“STREAK”) is “1 PAGE(S)”, and the NG rate is “100%”. Each of the numbers of pages for “MISREGISTRATION (HORIZONTAL),” “MISREGISTRATION (VERTICAL)”, “STAIN (DOT),” and “READING FAILURE” is “0”, and it is shown that those aspects are not NG. In this manner, on the screen for showing the detailed information, further detailed information that is not displayed on the screen of the inspection results of FIG. 11 is displayed.

In addition, an area A1203 is an area for displaying the job name, and in this example, “JOB #2” is displayed. An area A1204 is an area for displaying whether the job is the test printing or the main printing, and in this example, “TEST PRINTING” is displayed. An area A1205 is an area for displaying the date and time of execution of the inspection, and in this example, “2022 Oct. 2 15:00:00” is displayed. Further, in the example of FIG. 12, the read image is displayed in the area A1201, and hence the user can visually recognize which printing the inspection result information is being checked for.

In the third embodiment, the user can know, even for an inspection the execution of which has been completed, the items of the inspection from a list screen that shows the inspection result information. In particular, the inspection result information includes the information on whether the test printing or the main printing has been executed and the information on the items of the inspection (for example, the inspection date and time, and the number of sheets that have resulted in NG), thereby allowing the inspection results to be easily checked. As described above, according to the third embodiment of the present disclosure, it is possible to check whether or not there is an error in the inspection settings by the test printing that is executed before the main printing, and hence it is possible to prevent NG paper from being caused by the printing inspection resulting in NG due to an error in the inspection settings in the main printing. In addition, it is possible to prevent occurrence of a rework of reviewing the inspection settings after the main printing, and therefore, it is possible to prevent a decrease in productivity.

As a modification example, when the main printing has been performed without changing the printing settings after the test printing, the items of the inspection result information can be changed. As illustrated in FIG. 11, the inspection result information includes the information on whether the test printing or the main printing has been executed and the information indicating the items of the inspection, such as the job name, the inspection date and time, and the NG count. Meanwhile, when the main printing has been executed without changing the printing settings after the test printing, the printing settings are unchanged, and hence it is less required to display the items of the inspection again. In contrast, it is highly important to check whether the test printing or the main printing has been performed. Therefore, when the main printing has been performed without changing the printing settings after the test printing, the items of the inspection result information may be changed so as to display only the information on whether the test printing or the main printing has been executed.

In another case, the items of the inspection result information may be changed so as to display information other than the items of the inspection, for example, information, such as a toner remaining amount and the number of remaining sheets, in addition to the information on whether the test printing or the main printing has been executed. Thus, the user is no longer required to check the information, such as the toner remaining amount and the number of remaining sheets, again, thereby improving productivity. Further, after the main printing inspection processing or the test printing inspection processing is ended, so-called recovery printing for executing the printing by the printer 300 after modifying the print image, the printing settings of the printer 300, and the inspection settings of the inspection apparatus 500 may be performed as the requirement arises.

As described above, according to at least one embodiment of the present disclosure, it is possible to suppress an increase in the number of sheets determined to have printing abnormalities during a print job. In the first to third embodiments, as a method of presenting information such as inspection results, a method in which the information is displayed on a screen so that the user can visually recognize the information is employed, but the present disclosure is not limited thereto, and the information may be presented by voice or the like. In addition, in the first to third embodiments, it is possible to prevent a rework of reviewing inspection settings after main printing while wastefully consuming sheets due to occurrence of “inspection NG” in the main printing when the inspection settings of an inspection apparatus are incorrect.

Further, the printing inspection apparatus executes a printing inspection in accordance with inspection settings, such as an inspection region and an inspection intensity (inspection level), which are provided in advance by the user. However, when the items of the inspection that have been provided are incorrect (different from those intended by the user), there is a possibility that the number of sheets determined to have printing abnormalities (inspection NG) as inspection results during print jobs may increase. Meanwhile, as described above, according to the at least one embodiment of the present disclosure, it is possible to suppress an increase in the number of sheets determined to have printing abnormalities during print jobs.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-127037, filed Aug. 3, 2023, which is hereby incorporated by reference herein in its entirety.

What is claimed is:

1. An image forming apparatus comprising:
an image forming unit configured to form an image on a sheet based on image data;
a reader configured to read the sheet on which the image has been formed;
an inspector configured to execute an inspection of a reading result of the image read by the reader;
a display configured to display an inspection result of the inspection executed by the inspector; and
a controller configured to execute main printing for controlling the image forming unit to form an image based on the image data, or test printing for controlling the image forming unit to form an image based on only a part of the image data,
wherein the display is configured to display, in a case where the test printing has been executed, first information indicating that the test printing has been executed and second information indicating an inspection result obtained by inspecting an image formed in the test printing by the inspector.

2. The image forming apparatus according to claim 1, wherein the display is configured to display, in a case where the main printing has been executed, third information indicating that the main printing has been executed and fourth information indicating an inspection result obtained by inspecting an image formed in the main printing by the inspector.

3. The image forming apparatus according to claim 1, wherein the controller is configured to control the inspector to execute the inspection in any one of a case of executing the main printing and a case of executing the test printing.

4. The image forming apparatus according to claim 1, wherein the image forming apparatus is configured to present whether the main printing or the test printing is being executed.

5. The image forming apparatus according to claim 1, further comprising a receiver configured to receive an operation from a user,
wherein the receiver includes:
a main printing receiver configured to receive an operation for instructing execution of the main printing; and
a test printing receiver configured to receive an operation for instructing execution of the test printing, and
wherein the controller is configured to control the inspector to execute the inspection in any one of a case in which the operation for instructing the execution of the main printing has been received through the main printing receiver and a case in which the operation for instructing the execution of the test printing has been received through the test printing receiver.

6. The image forming apparatus according to claim 1, further comprising a receiver configured to receive an operation from a user,
wherein the receiver includes:
a main printing receiver configured to receive an operation for instructing execution of the main printing; and
a test printing receiver configured to receive an operation for setting whether to execute the test printing,
wherein the controller is configured to:
execute the main printing in a case where the operation for instructing the execution of the main printing has been received through the main printing receiver under a state in which the test printing receiver has no setting that the test printing is to be executed; and
execute the test printing in a case where the operation for instructing the execution of the main printing has been received through the main printing receiver under a state in which the test printing receiver has a setting that the test printing is to be executed, and
wherein the controller is configured to control the inspector to execute the inspection irrespective of a setting in the test printing receiver.

7. The image forming apparatus according to claim 1, wherein the image forming apparatus is configured to present, after the inspector has executed the inspection, inspection result information including:
information indicating which of the main printing and the test printing has been executed; and
information indicating contents of the inspection.

8. The image forming apparatus according to claim 7,
wherein the controller is configured to control the image forming unit to form the image based on a predetermined printing setting, and
wherein the controller is configured to control the display to present, in a case where the main printing has been executed without changing the predetermined printing setting after the test printing had been executed, the information indicating which of the main printing and the test printing has been executed and information other than information indicating a result of the inspection.

9. The image forming apparatus according to claim 1, wherein the test printing includes printing a part of a page to be printed.

10. The image forming apparatus according to claim 1, wherein the test printing includes printing fewer copies than a specified plurality of number of copies to be printed.

11. The image forming apparatus according to claim 1,
further comprising a receiver configured to receive an operation for eliminating requirement of the inspection of the reading result, and
wherein the controller is configured to:
prevent the inspector from executing the inspection in a case where an operation for instructing execution of the main printing has been received under a state in which the operation for eliminating the requirement of the inspection of the reading result had been received by the receiver; and
control the inspector to execute the inspection in a case where an operation for instructing execution of the test printing has been received under a state in which the operation for eliminating the requirement of the inspection of the reading result had been received by the receiver.
